(19) United States
(12) Patent Application Publication
(10) Pub. No.: US 2026/0361122 A1
(43) Pub. Date: Nov. 12, 2026

(54) CONTROL DATA GENERATION APPARATUS, CONTROL METHOD, AND CONTROL PROGRAM

(71) Applicant: Sony Group Corporation, Tokyo (JP)

(72) Inventors: Daisuke Kawamoto, Kanagawa (JP); Kotaro Jinushi, Tokyo (JP)

(73) Assignee: Sony Group Corporation, Tokyo (JP)

(21) Appl. No.: 19/122,096

(22) PCT Filed: Oct. 13, 2023
(86) PCT No.: PCT/JP2023/037158

§ 371 Date: Apr. 17, 2025

(30) Foreign Application Priority Data
Oct. 26, 2022 (JP) 2022-171302

(51) Int. Cl. H02J 13/12; H02J 7/00

(52) U.S. Cl. CPC H02J 13/12; H02J 7/865

(57) ABSTRACT

The control data generation apparatus generates control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses, transmits data indicating at least the scenario among the control data generated to a power storage apparatus corresponding, and transmits data indicating at least the requested power amount among the control data generated to an integration unit that communicates with the plurality of power storage apparatuses. The charging and discharging includes a first power exchange that is a power exchange between the entire plurality of power storage apparatuses and the power grid, the first power exchange being performed on the basis of an exchange adjustment result between the integration unit and the plurality of power storage apparatuses, and a second power exchange that is a power exchange between the plurality of power storage apparatuses, the second power exchange being performed on the basis of an exchange adjustment result between the plurality of power storage apparatuses.

### FIELD

The present disclosure relates to a control data generation apparatus, a control method, and a control program.

### BACKGROUND

For example, as disclosed in Patent Literature 1, it is known that power exchange is performed among a plurality of power storage apparatuses.

### CITATION LIST

### Patent Literature

Patent Literature 1: JP 2021-44972 A

### SUMMARY

### Technical Problem

If power exchange between the entire plurality of power storage apparatuses and the power grid is also possible, it can be used for, for example, securing of power supply, power supply and demand balancing, and the like.

One aspect of the present disclosure enables both power exchange between the entire plurality of power storage apparatuses and the power grid and power exchange between the plurality of storage batteries.

### Solution to Problem

A control data generation apparatus according to one aspect of the present disclosure performs: generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses; transmitting data indicating at least the scenario among the control data generated to a power storage apparatus corresponding; and transmitting data indicating at least the requested power amount among the control data generated to an integration unit that communicates with the plurality of power storage apparatuses, wherein the charging and discharging includes: a first power exchange that is a power exchange between the entire plurality of power storage apparatuses and the power grid, the first power exchange being performed on a basis of an exchange adjustment result between the integration unit and the plurality of power storage apparatuses; and a second power exchange that is a power exchange between the plurality of power storage apparatuses, the second power exchange being performed on a basis of an exchange adjustment result between the plurality of power storage apparatuses.

A control method according to one aspect of the present disclosure includes: generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses; transmitting data indicating at least the scenario among the control data generated to a power storage apparatus corresponding; and transmitting data indicating at least the requested power amount among the control data generated to an integration unit that communicates with the plurality of power storage apparatuses, wherein the charging and discharging includes: a first power exchange that is a power exchange between the entire plurality of power storage apparatuses and the power grid, the first power exchange being performed on a basis of an exchange adjustment result between the integration unit and the plurality of power storage apparatuses; and a second power exchange that is a power exchange between the plurality of power storage apparatuses, the second power exchange being performed on a basis of an exchange adjustment result between the plurality of power storage apparatuses.

A control program according to one aspect of the present disclosure causes a computer to execute processing of: generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses; transmitting data indicating at least the scenario among the control data generated to a power storage apparatus corresponding; and transmitting data indicating at least the requested power amount among the control data generated to an integration unit that communicates with the plurality of power storage apparatuses, wherein the charging and discharging includes: a first power exchange that is a power exchange between the entire plurality of power storage apparatuses and the power grid, the first power exchange being performed on a basis of an exchange adjustment result between the integration unit and the plurality of power storage apparatuses; and a second power exchange that is a power exchange between the plurality of power storage apparatuses, the second power exchange being performed on a basis of an exchange adjustment result between the plurality of power storage apparatuses.

### BRIEF DESCRIPTION OF DRAWINGS

FIG. 1 is a diagram illustrating an example of a schematic configuration of a power system including a control apparatus according to an embodiment.

FIG. 2 is a block diagram illustrating an example of a schematic configuration of a power system.

FIG. 3 is a diagram illustrating an example of time division in the first power exchange.

FIG. 4 is a flowchart illustrating an example of a process (control method) executed in the first power exchange.

FIG. 5 is a flowchart illustrating an example of a process (control method) executed in the second power exchange.

FIG. 6 is a diagram illustrating an example.

FIG. 7 is a diagram illustrating an example of an electricity market.

FIG. 8 is a block diagram illustrating an example of a schematic configuration of a power system.

FIG. 9 is a diagram illustrating an example of cooperation with the market.

FIG. 10 is a diagram illustrating an example of scenario update.

FIG. 11 is a diagram illustrating an example of a UI.

FIG. 12 is a diagram illustrating another example of the UI.

FIG. 13 is a diagram illustrating an example of a hardware configuration of an apparatus or the like.

### DESCRIPTION OF EMBODIMENTS

Hereinafter, embodiments of the present disclosure will be described in detail with reference to the drawings. Note that, in the following embodiments, the same elements are denoted by the same reference signs, and redundant description will be omitted.

The present disclosure will be described according to the following order of items.
0. Introduction
1. Embodiments
2. Examples
3. Example of Priority According to Mode Selection Information
4. Application Examples
5. Example of Hardware Configuration
6. Effects of Examples

### 0. INTRODUCTION

The power balancing group and the retailer (hereinafter, it is also referred to as a “retailer or the like”) are required to operate such that the plan value and the actual value of the power supply and demand always match each other. The state in which the plan value does not match the actual value is also referred to as imbalance. In particular, when a shortage imbalance, that is, a state in which the demand is larger than the supply occurs, the retail electricity provider or the like has to pay the imbalance cost to the power transmission and distribution provider, which is also a problem in management.

In recent years, introduction of a virtual power plant (VPP) in which distributed resources of power generation apparatuses using renewable energy installed in consumers (house, factory, or the like) and power storage apparatuses including storage batteries connected thereto are intensively arranged has been studied. The plurality of power storage apparatuses in the VPP can exchange power with each other such that, for example, each SOC approaches the target SOC.

If the power storage apparatus in the VPP can exchange power with power grid other than the VPP, for example, a power grid managed by a power transmission and distribution provider, it is possible to help securing a supply power by a retail electricity provider or the like. In addition, surplus power can be absorbed to be used for supply and demand balancing. However, in this case, the power storage apparatus in the VPP needs to keep the power amount that may be requested, and there is a problem that the consumer cannot freely use the corresponding power.

According to the disclosed technology, the two types of power exchange are performed in cooperation so as to achieve both the power exchange (first power exchange) between the plurality of power storage apparatuses and the power grid and the power exchange (second power exchange) between the plurality of power storage apparatuses. Some examples of specific approaches are described in subsequent embodiments.

### 1. EMBODIMENTS

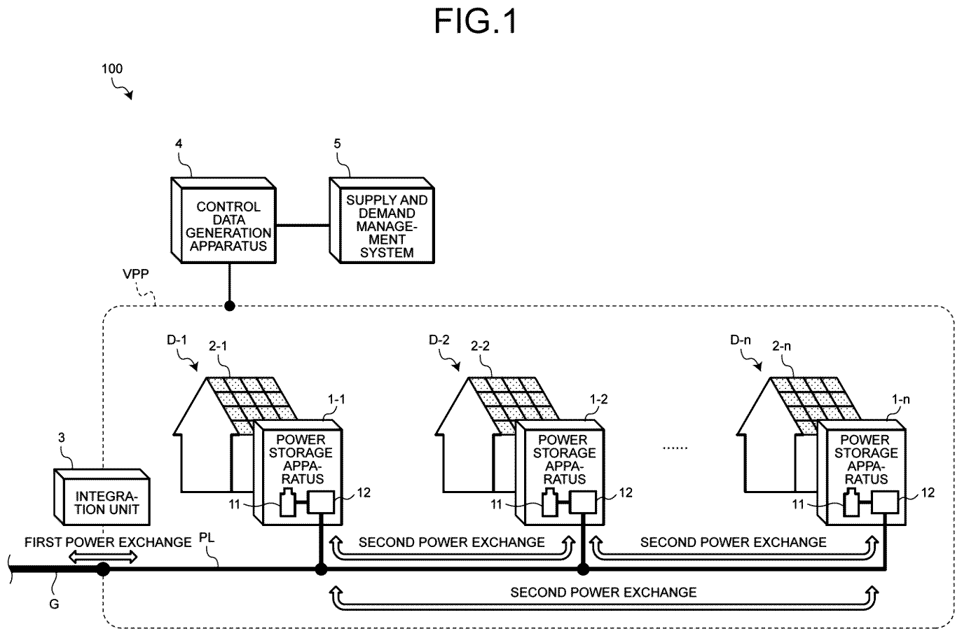

FIG. 1 is a diagram illustrating an example of a schematic configuration of a power system including a control apparatus according to an embodiment. An example of users of a power system 100 is illustrated as a plurality of consumers D. Each consumer D is referred to as a consumer D-1, a consumer D-2, and a consumer D-n so as to be distinguishable. It similarly applies to a power storage apparatus 1 and a power generation apparatus 2 described later. A specific example of the consumer D is a house, a facility, or the like, and more specifically, may indicate a user who uses electricity in such a place. The plurality of consumers D cooperatively provides (configures) the virtual power plant VPP, for example, by belonging to the same community.

The power system 100 includes a power storage apparatus 1, a power generation apparatus 2, an integration unit 3, a control data generation apparatus 4, a supply and demand management system 5, and a power line PL. The elements are configured to be able to communicate with each other as necessary.

The power storage apparatus 1 and the power generation apparatus 2 are provided at the consumer D. In the example illustrated in FIG. 1, the power storage apparatus 1 is a plurality of power storage apparatuses 1 respectively provided and used by corresponding consumers D. The power generation apparatus 2 is a plurality of power generation apparatuses 2 respectively provided and used by corresponding consumers D.

The power line PL extends, for example, in the virtual power plant VPP so as to connect the plurality of power storage apparatuses 1. The plurality of power storage apparatuses 1 is connected in parallel to the power line PL. In addition, the power line PL is also connected to the power grid G. Each of the plurality of power storage apparatuses 1 is connected to the power grid G via the power line PL. With such a connection, power exchange between the entire plurality of power storage apparatuses 1 and the power grid G and power exchange between the plurality of power storage apparatuses 1 can be performed. The former is referred to as a “first power exchange”, and the latter is referred to as a “second power exchange”, which are schematically illustrated by outlined arrows.

The power storage apparatus 1 includes a storage battery 11 and a power converter 12. The storage battery 11 is a chargeable/dischargeable secondary battery. Various known secondary batteries may be used. The power converter 12 is connected between the storage battery 11 and the power line PL, and controls charging and discharging of the storage battery 11. For example, the power converter 12 charges the storage battery 11 by converting AC power from the power line PL into DC power and supplying the DC power to the storage battery 11. The power converter 12 converts DC power from the storage battery 11 into AC power and supplies the AC power to the power line PL to discharge the storage battery 11. The power converter 12 is also referred to as a power conditioner, a bidirectional inverter, or the like.

The flow of power from the power storage apparatus 1 to the power line PL is also referred to as discharging or the like of the power storage apparatus 1.

The flow of power from the power line PL to the power storage apparatus 1 is also referred to as charging or the like of the power storage apparatus 1. In addition, charging and discharging of the power storage apparatus 1 are also referred to as demand, supply, and the like. Discharging and charging are collectively referred to as charge and discharge (or supply and demand) or the like. A state of charge (SOC) indicating the residual capacity of the storage battery 11 of the power storage apparatus 1 is also simply referred to as an SOC of the power storage apparatus 1.

The power generation apparatus 2 generates power using, for example, renewable energy. The power generation apparatus 2 illustrated in FIG. 1 is a solar power generation apparatus, but is not limited thereto, and various known power generation apparatuses may be used. At least a part of the generated power of the power generation apparatus 2 can be consumed by the consumer D. In addition, out of the generated power of the power generation apparatus 2, power not consumed by the consumer D is charged in the storage battery 11 of the power storage apparatus 1 or supplied to the power line PL via, for example, the power converter 12. The power charged in the storage battery 11 is consumed by the consumer D or supplied to the power line PL via the power converter 12.

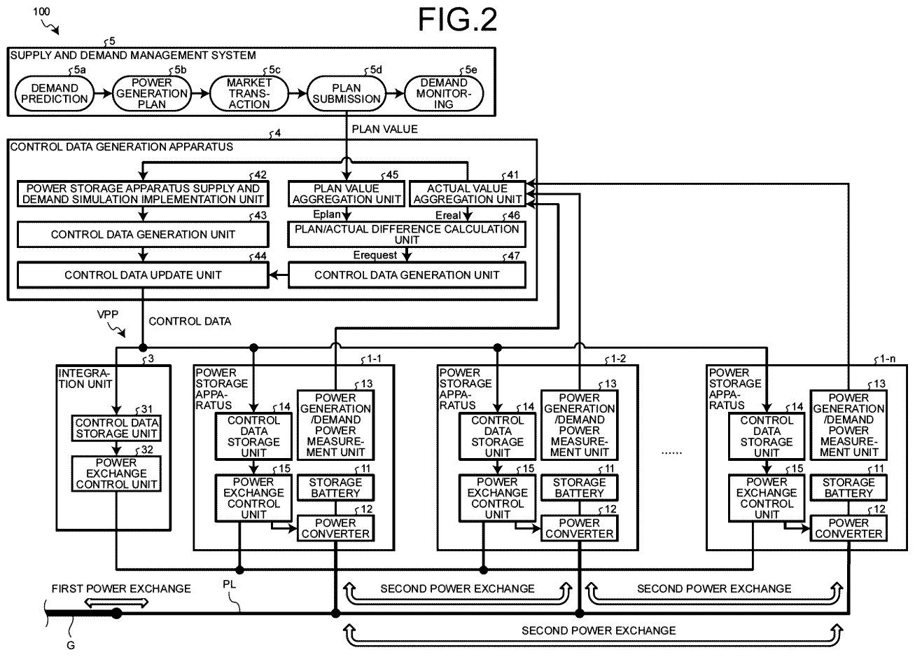

The integration unit 3 communicates with the plurality of power storage apparatuses 1. The control data generation apparatus 4 generates control data and transmits (also referred to as “distributes”) the control data to each of the plurality of power storage apparatuses 1 and the integration unit 3. The supply and demand management system 5 is operated or provided by, for example, a retail electricity provider, a power transmission and distribution provider, or the like. Further details of the power system 100 will be described with reference to FIG. 2.

FIG. 2 is a block diagram illustrating an example of a schematic configuration of a power system. Note that illustration of the consumer D and the power generation apparatus 2 (FIG. 1) is omitted. In addition to the storage battery 11 and the power converter 12 described above, the power storage apparatus 1 includes a power generation/demand power measurement unit 13, a control data storage unit 14, and a power exchange control unit 15. The integration unit 3 includes a control data storage unit 31 and a power exchange control unit 32. The control data generation apparatus 4 includes an actual value aggregation unit 41, a power storage apparatus supply and demand simulation implementation unit 42, a control data generation unit 43, a control data update unit 44, a plan value aggregation unit 45, a plan/actual difference calculation unit 46, and a control data generation unit 47. In addition, FIG. 2 illustrates some processes executed in the supply and demand management system 5.

### Base Scenario

First, a basic operation of the power storage apparatus 1 will be described. Each of the plurality of power storage apparatuses 1 is charged and discharged so as to approach a given target SOC. The target SOC is given by the control data generation apparatus 4 as described later.

In the power storage apparatus 1, the power generation/demand power measurement unit 13 measures generated power of the power generation apparatus 2 and measures charge/discharge power of the power storage apparatus 1. The measurement result includes an actual value of the generated power amount and an actual value of the charge/discharge power amount. The power generation/demand power measurement unit 13 transmits (data indicating) the actual value to the control data generation apparatus 4. The power generation/demand power measurement unit 13 includes, for example, a power meter, a communication device, and the like. The power generation/demand power measurement unit 13 may be a so-called smart meter.

In the control data generation apparatus 4, the actual value aggregation unit 41 acquires actual values from the respective power storage apparatuses 1 and aggregates (sums or the like) the actual values. Various processes other than this, for example, aggregation of past actual values, and the like may also be performed by the actual value aggregation unit 41.

The power storage apparatus supply and demand simulation implementation unit 42 performs a simulation based on the actual value of each power storage apparatus 1 acquired by the actual value aggregation unit 41. This simulation includes calculation of transition of future SOC of each power storage apparatus 1. The calculation is performed on the basis of, for example, the past generated power amount of the power generation apparatus 2 corresponding to each power storage apparatus 1, the charge/discharge power amount of the power storage apparatus 1, and the like. The simulation may be performed on the basis of other information. Examples of the other information include future weather, temperature, and humidity, day of week and holiday information, and schedule of the consumer D.

The control data generation unit 43 calculates the target SOC of each of the plurality of power storage apparatuses 1 on the basis of the simulation result of the power storage apparatus supply and demand simulation implementation unit 42. More specifically, the control data generation unit 43 generates a scenario describing a target SOC for a future time of each of the power storage apparatuses 1. For example, the temporal transition of the target SOC over 24 hours of the next day is described by the scenario. The control data generation unit 43 generates control data indicating a scenario.

The scenario may be calculated in consideration of the purpose of the consumer D and the like. Examples of the purpose are surplus power minimization, deficient power minimization, power cost minimization, disaster countermeasures, and the like. For example, each power storage apparatus 1 is configured such that an operation mode thereof can be selected from a plurality of modes having different purposes. Examples of the mode include a surplus power minimization mode, a power cost minimization mode, a deficient power minimization mode, and a disaster countermeasure mode. Information (mode selection information) indicating the selected mode may be transmitted from each power storage apparatus 1 to the control data generation apparatus 4. The control data generation unit 43 generates control data indicating a scenario according to the purpose of the mode on the basis of the mode selection information.

The control data update unit 44 transmits the control data generated by the control data generation unit 43, that is, the data indicating the scenario to the corresponding power storage apparatus 1. Data indicating the scenario of the power storage apparatus 1-1 is transmitted to the power storage apparatus 1-1. Data indicating the scenario of the power storage apparatus 1-2 is transmitted to the power storage apparatus 1-2. Data indicating the scenario of the power storage apparatus 1-nis transmitted to the power storage apparatus 1-n.

In the power storage apparatus 1, the control data storage unit 14 receives and stores the control data from the control data generation apparatus 4. The power exchange control unit 15 controls the power converter 12 on the basis of the control data. Specifically, the power storage apparatus 1 charges or discharges the power storage apparatus 1 such that the SOC of the power storage apparatus 1 approaches the target SOC described by the scenario indicated in the control data.

### Update Scenario

Next, the first power exchange will be described. The scenario is updated to implement the first power exchange.

In the supply and demand management system 5, power demand prediction for the power grid G is performed (process 5a), and a power generation plan based on the prediction result is generated (process 5b). Market transactions based on the power generation plan are performed (process 5c), and a plan determined on the basis of the transaction results is submitted (process 5d). The plan here includes a plan value of the charge/discharge power amount (that is, the power supply and demand of the virtual power plant VPP) with respect to the power grid G of the entire plurality of power storage apparatuses 1. Data indicating the plan value is transmitted from the supply and demand management system 5 to the control data generation apparatus 4. Note that, after the plan is submitted, the actual power supply and demand of the power grid G is monitored (process 5e).

The plan value may be one period obtained by dividing one day into a plurality of periods. Unless otherwise specified, it is assumed below that one day is divided into 48 unit periods (slots), and the length of each unit period is 30 minutes. The plan value may be a plan value in a unit period. The plan value for each of the plurality of unit periods may be transmitted from the supply and demand management system 5 to the control data generation apparatus 4.

In the control data generation apparatus 4, the plan value aggregation unit 45 acquires (receives) the plan value from the supply and demand management system 5.

The plan/actual difference calculation unit 46 calculates a difference between the plan value acquired by the plan value aggregation unit 45 and the actual value of the charge/discharge power amount with respect to the power grid G of the entire plurality of power storage apparatuses 1 acquired and aggregated by the actual value aggregation unit 41. The power amount corresponding to the difference is a power amount to be charged and discharged by the entire plurality of power storage apparatuses 1 with respect to the power grid G, and is referred to as a requested power amount Erequest.

Note that the plan value is referred to as a plan value Eplan. The actual measurement value is referred to as an actual value Ereal. The actual value Ereal may be a value in the unit period, similarly to the plan value Eplan. Unless otherwise specified, the plan value Eplan and the actual value Ereal are demand, that is, the plan value and the actual value of the charge power amount of the entire plurality of power storage apparatuses 1.

The control data generation unit 47 generates control data indicating the scenario and the requested power amount Erequest of each of the plurality of power storage apparatuses 1 on the basis of the calculation result of the plan/actual difference calculation unit 46.

In this scenario, the target SOC with respect to the time of each of the plurality of power storage apparatuses 1 is described such that the actual value Ereal approaches the plan value Eplan, in other words, such that the difference therebetween is compensated.

Note that, similarly to the control data generation unit 43 described above, the control data generation unit 47 may also generate the control data in consideration of the mode selection information of each power storage apparatus 1.

The control data update unit 44 transmits the control data generated by the control data generation unit 47 to the plurality of power storage apparatuses 1 and the integration unit 3. Among the control data, data indicating at least the scenario is transmitted to the corresponding power storage apparatus 1. Data indicating at least the requested power amount Erequest among the control data is transmitted to the integration unit 3.

In the power storage apparatus 1, the control data storage unit 14 receives and stores the control data from the control data generation apparatus 4. The control data already received and stored is overwritten, for example, by the current control data. That is, the scenario is updated.

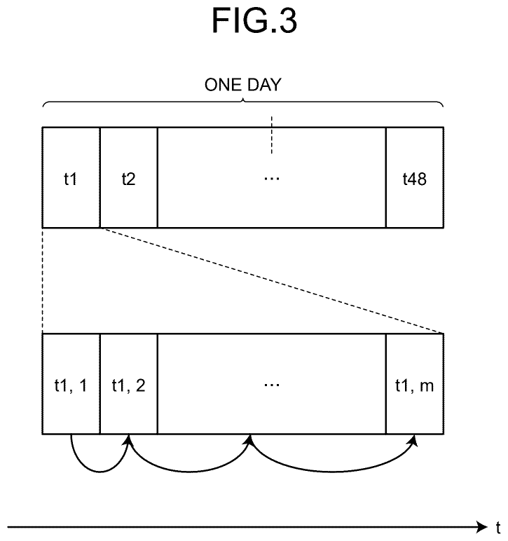

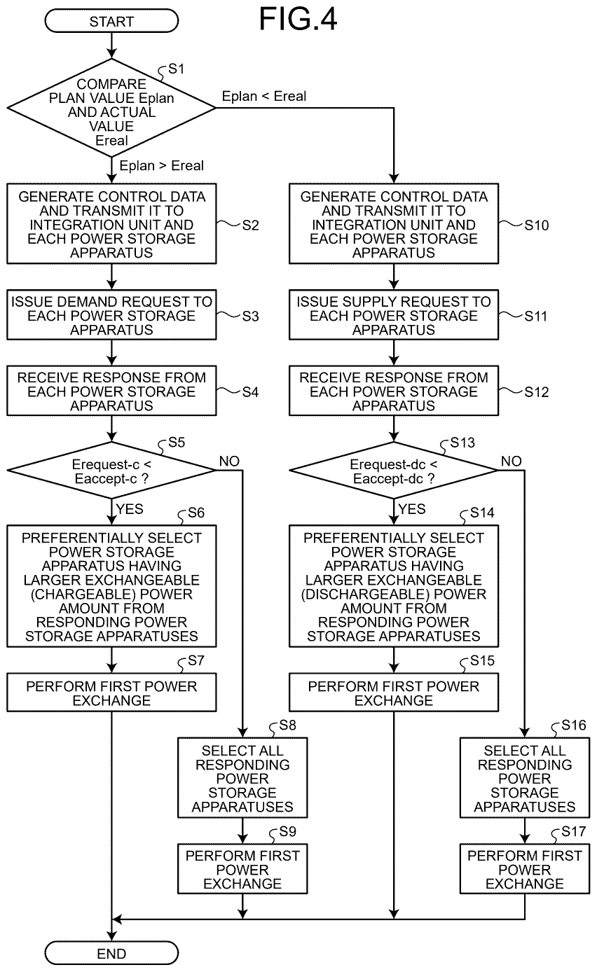

In the integration unit 3, the control data storage unit 31 receives and stores the control data from the control data generation apparatus 4. The power exchange control unit 32 communicates with the power exchange control unit 15 of the power storage apparatus 1 and performs power exchange adjustment. This exchange adjustment is an adjustment for causing the entire plurality of power storage apparatuses 1 to charge and discharge the power amount corresponding to the requested power amount Erequest with respect to the power grid G. The first power exchange is performed on the basis of the exchange adjustment result. In the first power exchange, at least some power storage apparatuses 1 of the plurality of power storage apparatuses 1 charge or discharge the power with respect to the power grid G such that charge/discharge power of the entire plurality of power storage apparatuses 1 with respect to the power grid G approaches the requested power amount Erequest. The first power exchange will be described with reference to FIGS. 3 and 4.

FIG. 3 is a diagram illustrating an example of time division in the first power exchange. Time t corresponding to each unit period (in this example, unit period=30 minutes) in one day is referred to as time t1 to time t48. The time t indicates, for example, a start time of a corresponding unit period.

In each unit period, the power exchange is performed such that the actual value Ereal approaches the plan value Eplan. One unit period is divided into a plurality of periods. The period after the division is referred to as a division period. For example, one unit period is divided into m equal parts. That is, each of the unit periods corresponding to the time t1 to the time t48 is divided into m equal parts. By dividing the unit period corresponding to the time t1 into m equal parts, m division periods corresponding to the times t1, 1 to t1, m are obtained. It similarly applies to the other times t2 to t48. The number of m is not particularly limited, but may be, for example, about 5 to 6.
t1=t1, 1, t1, 2, . . . t1, m
t2=t2, 1, t2, 2, . . . t2, m
. . .
t48=t48, 1, t48, 2, . . . t48, m

At least some power storage apparatuses 1 of the plurality of power storage apparatuses 1 charge or discharge the power with respect to the power grid G such that a value (=Ereal/m) for the division period of the actual value Ereal approaches a value (Eplan/m) for the division period of the plan value Eplan for each division period. From a difference between respective values in a certain division period, charge/discharge power amounts of the entire plurality of power storage apparatuses 1 for the next division period are obtained.

Specifically, in the first power exchange, the integration unit 3 selects one or more power storage apparatuses 1 that can charge or discharge the power with respect to the power grid G from the plurality of power storage apparatuses 1. The selected power storage apparatus 1 charges or discharges the power with respect to the power grid G such that the charge/discharge power amount of the entire power storage apparatus 1 selected by the integration unit 3 with respect to the power grid G approaches the requested power amount Erequest. A description will be given with reference to FIG. 4.

FIG. 4 is a flowchart illustrating an example of a process (control method) executed in the first power exchange. Description of contents overlapping with the above description will be omitted as appropriate.

The processes of steps S1 and S2 are executed by the control data generation apparatus 4.

In step S1, for example, the plan/actual difference calculation unit 46 compares the plan value Eplan with the actual value Ereal. In a case where the plan value Eplan is larger than the actual value Ereal (Eplan>Ereal), the process proceeds to step S2. In a case where the plan value Eplan is smaller than the actual value Ereal (Eplan<Ereal), the process proceeds to step S10.

In step S2, the plan/actual difference calculation unit 46 calculates a requested power amount Erequest corresponding to a difference between the plan value Eplan and the actual value Ereal. Here, the requested power amount Erequest is a charge power amount with respect to the power grid G of the entire plurality of power storage apparatuses 1, and is also referred to as a requested charge power amount Erequest-c. The control data generation unit 47 generates control data indicating the scenario of each of the plurality of power storage apparatuses 1 and the requested charge power amount Erequest-c. This control data indicates a scenario in which the charge power amount of the entire plurality of power storage apparatuses 1 with respect to the power grid G is updated to be large. The control data update unit 44 transmits the control data to the plurality of power storage apparatuses 1 and the integration unit 3.

The processes of steps S3 to S6 and S8 are executed by the integration unit 3.

In step S3, the power exchange control unit 32 issues a demand request to each power storage apparatus 1. The issuance of the demand request includes an inquiry about the exchangeable power amount of each power storage apparatus 1, more specifically, the chargeable power amount in this example.

In step S4, the power exchange control unit 32 receives a response from each of the power storage apparatuses 1. The response includes information indicating the exchangeable power amount of each power storage apparatus 1. The total power amount of the exchangeable power amounts of the power storage apparatuses 1 that have responded is referred to as an exchangeable power amount Eaccept. Here, the exchangeable power amount Eaccept corresponds to a charge power amount, and thus is also referred to as a chargeable power amount Eaccept-c. Note that the power storage apparatus 1 which does not charge may not respond.

In step S5, the power exchange control unit 32 compares the requested charge power amount Erequest-c with the chargeable power amount Eaccept-c. In this example, it is determined whether or not the requested charge power amount Erequest-c is smaller than the chargeable power amount Eaccept-c. In a case where the requested charge power amount Erequest-c is smaller than the chargeable power amount Eaccept-c (step S5: Yes), the process proceeds to step S6. Otherwise (step S5: No), the process proceeds to step S8.

In step S6, the power exchange control unit 32 preferentially selects the power storage apparatus 1 having a larger exchangeable power amount, here, the chargeable power amount, from the responding power storage apparatuses 1. For example, the power storage apparatus 1 having the larger chargeable power amount is selected in order until the sum of the chargeable power amounts of the selected power storage apparatuses 1 becomes the requested charge power amount Erequest-c.

In step S7, the first power exchange is performed. Each power storage apparatus 1 selected by the integration unit 3 controls the power converter 12 according to the update scenario and charges from the power grid G for a certain period of time (for example, the above-described division period). As a result, the actual value Ereal over the unit period approaches the plan value Eplan.

In step S8, the power exchange control unit 32 selects all the responding power storage apparatuses 1.

In step S9, the first power exchange is performed. The power storage apparatus 1 selected by the integration unit 3 charges from the power grid G according to the update scenario. The actual value Ereal over the unit period approaches the plan value Eplan.

The process of step S10 is executed by the control data generation apparatus 4. The plan/actual difference calculation unit 46 calculates a requested power amount Erequest corresponding to a difference between the plan value Eplan and the actual value Ereal. Here, the requested power amount Erequest is a discharge power amount with respect to the power grid G of the entire plurality of power storage apparatuses 1, and is also referred to as a requested discharge power amount Erequest-dc. The control data generation unit 47 generates control data indicating the scenario of each of the plurality of power storage apparatuses 1 and the requested discharge power amount Erequest-dc. This control data indicates a scenario in which the discharge power amount of the entire plurality of power storage apparatuses 1 with respect to the power grid G is updated to be large. The control data update unit 44 transmits the control data to each of the plurality of power storage apparatuses 1 and the integration unit 3.

The processes of steps S11 to S14 and S17 are executed by the integration unit 3.

In step S11, the power exchange control unit 32 issues a supply request to each power storage apparatus 1. The issuance of the supply request includes an inquiry about the exchangeable power amount of each power storage apparatus 1, more specifically, the dischargeable power amount in this example.

In step S12, the power exchange control unit 32 receives a response from each of the power storage apparatuses 1. The response includes information indicating the exchangeable power amount of each power storage apparatus 1. The total power amount of the exchangeable power amounts of the respective power storage apparatuses 1 that have responded is the exchangeable power amount Eaccept, and corresponds to the discharge power amount here, and thus is also referred to as the dischargeable power amount Eaccept-dc. Note that the power storage apparatus 1 which does not discharge may not respond.

In step S13, the power exchange control unit 32 compares the requested discharge power amount Erequest-dc and the dischargeable power amount Eaccept-dc. In this example, it is determined whether or not the requested discharge power amount Erequest-dc is smaller than the dischargeable power amount Eaccept-dc. In a case where the requested discharge power amount Erequest-dc is smaller than the dischargeable power amount Eaccept-dc (step S13: Yes), the process proceeds to step S14. Otherwise (step S13: No), the process proceeds to step S16.

In step S14, the power exchange control unit 32 preferentially selects the power storage apparatus 1 having a larger exchangeable power amount (dischargeable power amount) among the responding power storage apparatuses 1. For example, the power storage apparatus 1 having the larger dischargeable power amount is selected in order until the sum of the dischargeable power amounts of the selected power storage apparatuses 1 becomes the requested discharge power amount Erequest-dc.

In step S15, the first power exchange is performed. Each power storage apparatus 1 selected by the integration unit 3 controls the power converter 12 according to the update scenario and discharges to the power grid G for a certain period of time (for example, the above-described division period). The actual value Ereal over the unit period approaches the plan value Eplan.

In step S16, the power exchange control unit 32 selects all the responding power storage apparatuses 1.

In step S17, the first power exchange is performed. The power storage apparatus 1 selected by the integration unit 3 discharges to the power grid G according to the update scenario. The actual value Ereal over the unit period approaches the plan value Eplan.

After the process of step S7, step S9, step S15, or step S17 is completed, the process of the flowchart ends. For example, the first power exchange is performed in this manner.

Returning to FIG. 2, the SOC of the power storage apparatus 1 may deviate from the target SOC due to unexpected power generation including charging and discharging by the first power exchange described above, demand fluctuation, and the like. For example, in such a case, the SOC of each power storage apparatus 1 is brought close to the target SOC by the second power exchange, that is, the power exchange between the plurality of power storage apparatuses 1.

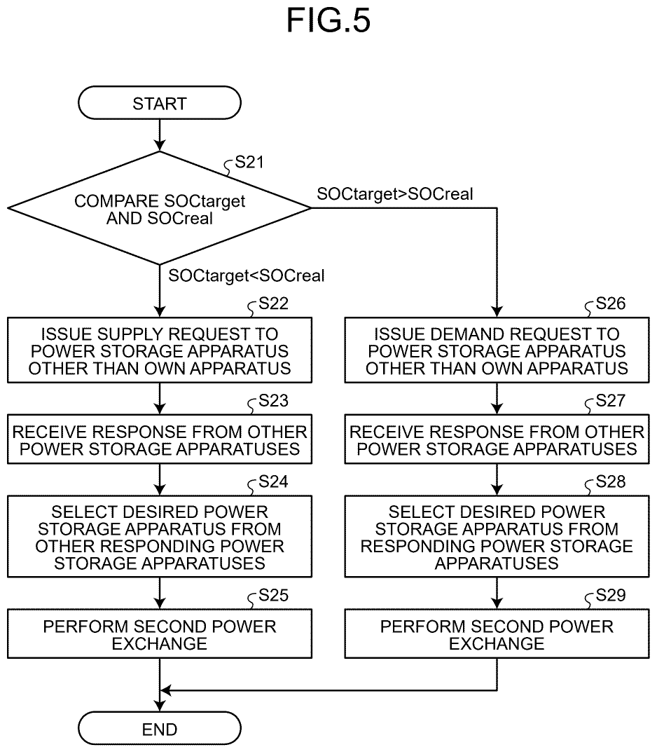

In the second power exchange, the power exchange control units 15 of the plurality of power storage apparatuses 1 communicate with each other and perform power exchange adjustment. The exchange adjustment is an adjustment for charging and discharging so as to bring the SOCs close to the target SOC. The second power exchange is performed on the basis of the exchange adjustment result. By charging and discharging such that the charge power amount (demand) of the charging power storage apparatus 1 and the discharge power amount (supply) of the discharging power storage apparatus 1 match each other, the charge/discharge power amount (supply and demand balance) with respect to the power grid G of the entire plurality of power storage apparatuses 1 is maintained. A description will be given with reference to FIG. 5.

FIG. 5 is a flowchart illustrating an example of a process (control method) executed in the second power exchange. The processes of steps S21 to S29 are executed in each of the plurality of power storage apparatuses 1. Note that, hereinafter, the SOC of the power storage apparatus 1 is also referred to as SoCreal. The target SOC of the power storage apparatus 1 is also referred to as SOCtarget.

In step S21, the power storage apparatus 1 compares SOCtarget and SOCreal. In a case where SOCreal is larger than SOCtarget (SOCtarget<SOCreal), the process proceeds to step S22. In a case where SOCreal is smaller than SOCtarget (SOCtarget>SOCreal), the process proceeds to step S26.

In step S22, the power exchange control unit 15 of the power storage apparatus 1 issues a supply request to the power storage apparatus 1 other than the own apparatus. The supply here means that the own apparatus supplies power to the other power storage apparatus 1. The issuance of the supply request may include an inquiry about the exchangeable power amount, more specifically, the chargeable power amount of the other power storage apparatus 1.

In step S23, the power exchange control unit 15 receives a response from other power storage apparatuses 1. The response may include information indicating the exchangeable (chargeable) power amount of each power storage apparatus 1. Note that the power storage apparatus 1 which does not charge may not respond.

In step 24, the power exchange control unit 15 selects a desired power storage apparatus 1 from the other responding power storage apparatuses 1. For example, the power storage apparatus 1 having a large chargeable power amount may be preferentially selected.

In step S25, the second power exchange is performed. The own apparatus discharges, and the selected power storage apparatus 1 charges the discharge power. SOCreal of the own apparatus approaches SOCtarget while the charge/discharge power amount of the entire plurality of power storage apparatuses 1 with respect to the power grid G is maintained.

In step S26, the power exchange control unit 15 of the power storage apparatus 1 issues a demand request to the power storage apparatus 1 other than the own apparatus. The demand here means that other power storage apparatuses 1 supply power to the own apparatus. The issuance of the demand request may include an inquiry about the exchangeable power amounts, more specifically, the dischargeable power amounts of other power storage apparatuses 1.

In step S27, the power exchange control unit 15 receives responses from other power storage apparatuses 1. The response may include information indicating an exchangeable (dischargeable) power amount of each power storage apparatus 1. Note that the power storage apparatus 1 which does not discharge may not respond.

In step 28, the power exchange control unit 15 selects a desired power storage apparatus 1 from the other responding power storage apparatuses 1. For example, the power storage apparatus 1 having a large dischargeable power amount is preferentially selected.

In step S29, the second power exchange is performed. The selected power storage apparatus 1 discharges electricity, and the own apparatus charges the discharge power. SOCreal of the own apparatus approaches SOCtarget while the charge/discharge power amount of the entire plurality of power storage apparatuses 1 with respect to the power grid G is maintained.

After the process of step S25 or step S29 is completed, the process of the flowchart ends. For example, the second power exchange is performed in this manner. The scenario describing the target SOC of each power storage apparatus 1 may be appropriately updated and distributed such that the second power exchange is performed at a desired timing.

### 2. EXAMPLES

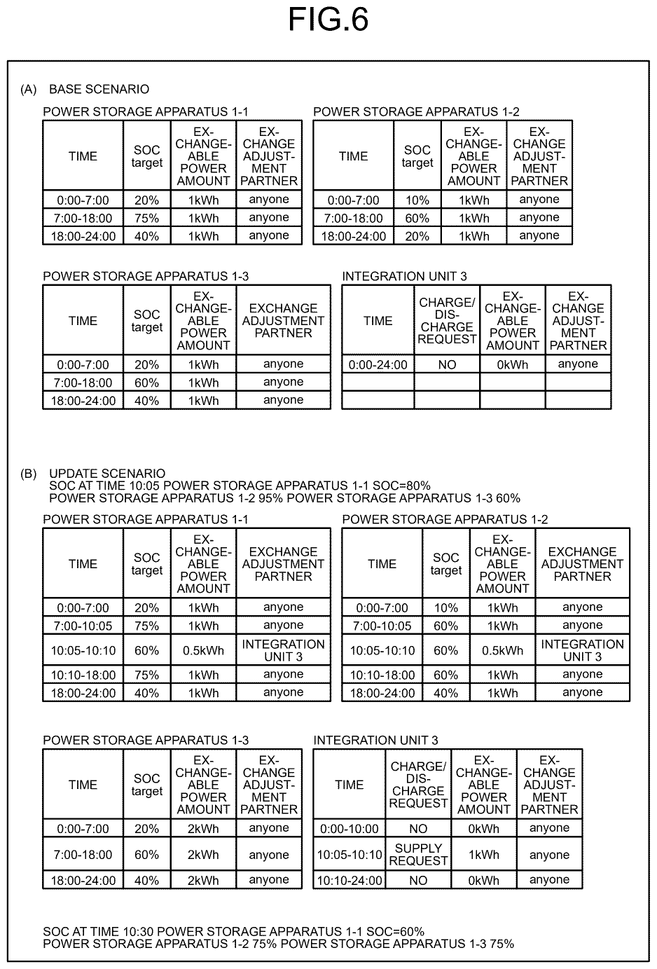

FIG. 6 is a diagram illustrating an example. Three power storage apparatuses 1 will be described as an example. The respective power storage apparatuses 1 are referred to as a power storage apparatus 1-1, a power storage apparatus 1-2, and a power storage apparatus 1-3 so that the power storage apparatuses 1 can be distinguished from each other. With respect to the power storage apparatus 1, a daily scenario is schematically illustrated. In the illustrated scenario, the time, the target SOC (SOCtarget), the exchangeable power amount, and the exchange adjustment partner are described in association with each other. The exchangeable power amount indicates a power amount that can be charged and discharged by the power storage apparatus 1. The exchange adjustment partner is a partner permitted to perform the power exchange adjustment, and only the power exchange adjustment with the exchange adjustment partner described here is permitted. Examples of the exchange adjustment partner include other power storage apparatuses 1 and integration units 3. anyone means that the exchange adjustment partner is not particularly limited.

(A) of FIG. 6 illustrates a base scenario. The base scenario is generated and distributed before the day starts, for example, the previous day. For example, the transition of the target SOC for charging and discharging the power storage apparatus 1 is described such that a time at which surplus power is generated and the power storage apparatus 1 cannot be charged or the power storage apparatus 1 cannot be discharged is not generated in one day. In the control data generation apparatus 4, a time at which the power storage apparatus 1 discharges and a discharge power amount thereof may be calculated in order to prevent generation of surplus power. The discharge power amount is a power amount that can be supplied (discharged) to the power grid G, that is, a power amount that can be proposed to be procured by a retail electricity provider, and can correspond to the plan value Eplan.

With respect to the integration unit 3, the illustrated scenario describes time, charge/discharge requests, exchangeable power amounts, and exchange adjustment partners in association with one another. At the stage of the base scenario, there may be no charge/discharge request and no exchangeable power amount.

After each power storage apparatus 1 actually starts charging and discharging, a difference between the plan value Eplan and the actual value Ereal described above may occur. New control data, that is, a scenario, is generated and updated so as to fill the difference.

Specifically, in this example, the power supply shortage occurs at 10:00 to 10:05 (plan value Eplan<actual value Ereal). The SOC of each power storage apparatus 1 at the time 10:05 is such that the SOC of the power storage apparatus 1-1 is 80%, the SOC of the power storage apparatus 1-2 is 95%, and the SOC of the power storage apparatus 1-3 is 60%.

(B) of FIG. 6 illustrates an update scenario. The base scenario is updated so that the actual value Ereal approaches the plan value Eplan. Data indicating the requested power amount Erequest is also distributed to the integration unit 3. The integration unit 3 issues a supply request to each power storage apparatus 1, and in this example, the power storage apparatus 1-1 and the power storage apparatus 1-2 are selected. When the power storage apparatus 1-1 and the power storage apparatus 1-2 discharge, the actual value Ereal approaches the plan value Eplan. Such first power exchange is performed among the power storage apparatus 1-1, the power storage apparatus 1-2, and the integration unit 3 during 10:05 to 10:10.

Here, data indicating a scenario for limiting exchange adjustment partners is transmitted to the corresponding power storage apparatus 1 so as to avoid overlapping implementation of the first power exchange and the second power exchange. In this example, the first power exchange is prioritized over the second power exchange.

Data indicating a scenario in which the exchange adjustment partner is limited to the integration unit 3 is transmitted to the power storage apparatus 1, the power storage apparatus 1-1, and the power storage apparatus 1-2, which charge and discharge the power with respect to the power grid G in the first power exchange.

Specifically, during 10:05 to 10:10, the exchange partner of the power storage apparatus 1-1 and the power storage apparatus 1-2 is limited to the integration unit 3. During that time, exchange adjustment is performed only between the power storage apparatus 1-1, the power storage apparatus 1-2, and the integration unit 3, and the first power exchange is performed on the basis of a result of the exchange adjustment. The second power exchange is not performed. After 10:10 when the first power exchange is ended, the limitation on the exchange partner is released.

Thereafter, in this example, the SOC of the power storage apparatus 1-1 falls below the target SOC at the time 10:30. On the other hand, both the SOC of the power storage apparatus 1-2 and the SOC of the power storage apparatus 1-3 exceed the target SOC. In order to bring the SOC of each power storage apparatus 1 close to the target SOC, the second power exchange is performed. For example, the power exchange may be performed between the power storage apparatus 1-1 and the power storage apparatus 1-3.

The power storage apparatus 1-3 discharges, and the power storage apparatus 1-1 charges the discharged power. The SOC of each of the power storage apparatus 1-1 and the power storage apparatus 1-3 is brought close to the target SOC.

### 3. EXAMPLE OF PRIORITY ACCORDING TO MODE SELECTION INFORMATION

As described above, a scenario based on the mode selection information of the power storage apparatus 1 may be generated. In an embodiment, data indicating a scenario may be generated such that the first power exchange and the second power exchange are performed on the basis of the priority according to the selected mode. Power exchange can be performed according to the purpose of the mode.

For example, depending on the consumer D, there is a case where it is desired to prioritize the securing of the SOC of the power storage apparatus 1 over the power supply (discharge) from the power storage apparatus 1 to the power grid G. In such a case, the disaster countermeasure mode may be selected by selecting the mode of the power storage apparatus 1. For example, when the disaster countermeasure mode is selected, control data indicating a scenario describing a target SOC that always secures an SOC is distributed. Control data for performing the first power exchange is not transmitted, the second power exchange is performed in preference to the first power exchange, and overlapping implementation is avoided.

An example of the disaster is a disaster caused by a typhoon or the like. For example, the control data for performing the first power exchange is not transmitted not only to the power storage apparatus 1 for which the disaster countermeasure mode is selected but also to all the power storage apparatuses 1 on the basis of the predicted date and time of the landing of the typhoon obtained from the weather information, whereby only the second power exchange can be performed to sufficiently secure the SOC of each power storage apparatus 1.

An example of the priority of the first power exchange according to the mode selection information will be described. For example, the priority of the first power exchange related to the discharge may be highest in the surplus power minimization mode, and may be lower in order of the power cost minimization mode, the deficient power minimization mode, and the disaster countermeasure mode.

In the surplus power minimization mode, discharge is actively performed so as not to generate surplus power.

It is first selected as discharge to the integration unit 3 (to the power grid G). In the power cost minimization mode, power exchange is performed on the basis of the power cost. By setting the power price of the power request from the integration unit 3 to be high, discharge is actively performed. In the deficient power minimization mode and the disaster countermeasure mode, basically, the discharge is hardly performed, and the discharge is performed only when there is a margin in the SOC.

In this manner, the priority of the first power exchange is determined on the basis of the mode selection information of each power storage apparatus 1, the power usage status at that time, and the like. When it is desired to prioritize the first power exchange, for example, when the power procurement of the retail electricity provider is difficult, the first power exchange can be prioritized by setting the power price of the first power exchange to be higher than that of the second power exchange. The power price may be indicated in the control data and may be used for exchange adjustment between the integration unit 3 and the power storage apparatus 1.

An example of a case where a power price is set in stages will be described. For example, a case is considered in which the power price is set to 20 yen when the SOC is 70%, the power price is set to 30 yen when the SOC is 50%, and the like in stages. If the normal market price of power is about 20 yen, the power exchange condition presented by the integration unit 3 is also set to 20 yen, so that the electricity transaction linked to the market price is performed. On the other hand, when power procurement is difficult, market prices also increase. For example, it is assumed to be 50 yen. The integration unit 3 can procure electricity from the corresponding power storage apparatus 1 at 30 yen lower than the market price by presenting 30 yen, which is higher than usual but lower than the increased market price. In addition, since the corresponding power storage apparatus 1 can also perform power transaction at a higher price than usual, it is possible to enjoy a monetary advantage.

### 4. APPLICATION EXAMPLES

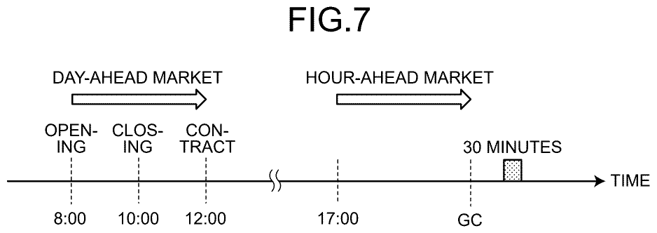

In the above embodiment, the control on that day, that is, the control executed after one hour before the start time of the unit period (slot) (after so-called gate closing) has been described as an example. In an embodiment, it is also possible to minimize the procurement cost by notifying the supply and demand management system 5 of the power amount that can be procured before the gate is closed. This will be described with reference to FIG. 7 to 10.

FIG. 7 is a diagram illustrating an example of an electricity market. Regarding the operation of the supply and demand balance, there are two markets. One market is the day-ahead market closed by 10:00 on the previous day.

Another market is the hour-ahead market closed one hour before each unit period (each slot) described above. The closing time corresponds to the gate closing (GC) time. A retail electricity provider or the like submits a plan of demand and supply of electricity on the day in the day-ahead market or the hour-ahead market.

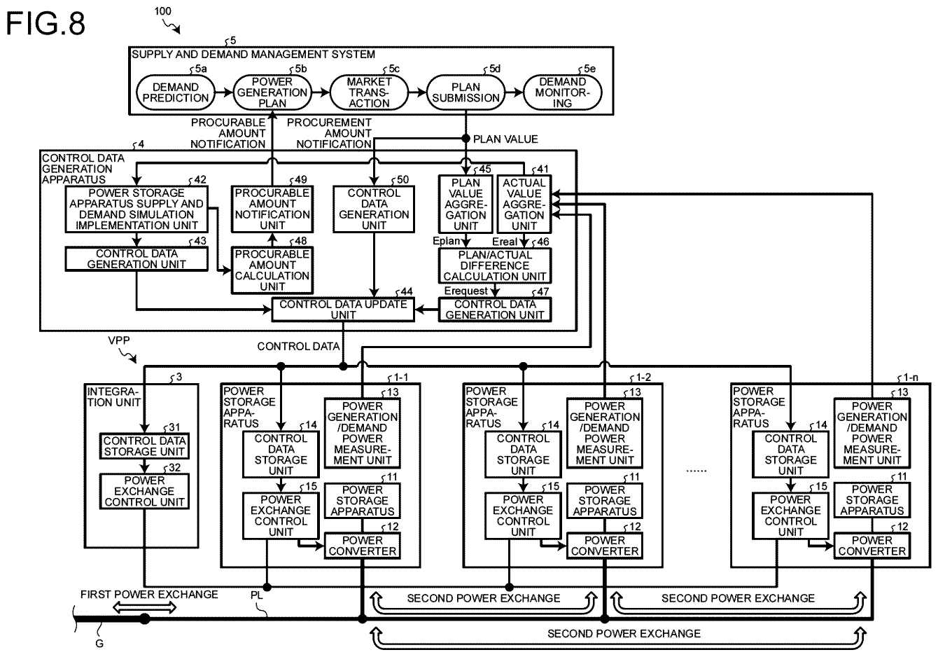

FIG. 8 is a block diagram illustrating an example of a schematic configuration of a power system. In this example, the control data generation apparatus 4 further includes a procurable amount calculation unit 48, a procurable amount notification unit 49, and a control data generation unit 50.

On the basis of the simulation result of the power storage apparatus supply and demand simulation implementation unit 42, the procurable amount calculation unit 48 calculates the surplus power of each power storage apparatus 1 as a power amount that can be procured (procurable amount). The procurable amount notification unit 49 notifies the supply and demand management system 5 of the procurable amount. The notified procurable power amount is considered in the power generation plan in the supply and demand management system 5.

In the supply and demand management system 5, the power storage apparatus 1 can be selected as an option of power procurement. For example, it is possible to select a desired procurement source after comparing the power procurement cost and amount with the power supply of the power storage apparatus 1 and the power supply of the other retail electricity providers. In a case where the power storage apparatus 1 is selected, the control data generation apparatus 4 is notified of the procurement amount.

In the control data generation apparatus 4, the control data generation unit 50 generates control data on the basis of the procurement amount notified from the supply and demand management system 5. The control data update unit 44 transmits the control data generated by the control data generation unit 50 to each power storage apparatus 1. By performing such control in both the day-ahead market and the hour-ahead market, it is possible to reliably procure power and maintain the supply and demand balance, thereby minimizing the imbalance cost by the retail electricity provider and the like.

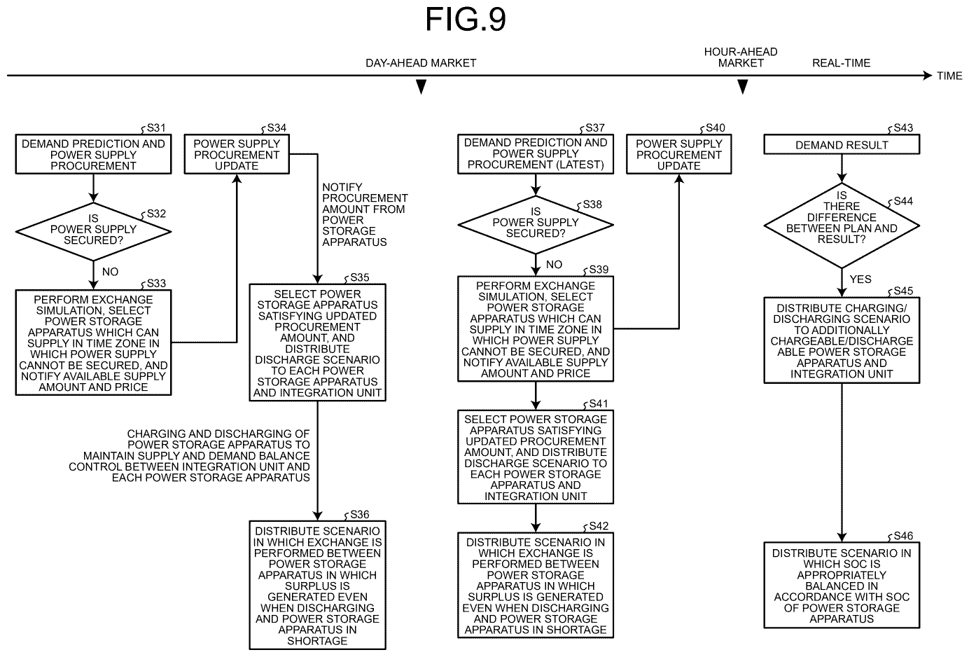

An example of cooperation between the two markets of the day-ahead market and the hour-ahead market as described above will be described with reference to FIG. 9.

FIG. 9 is a diagram illustrating an example of cooperation with the market. In the supply and demand management system 5, demand prediction and power supply procurement are performed (step S31). In a case where the power supply cannot be secured (step S32: No), for example, in the control data generation apparatus 4, an exchange simulation is performed, the power storage apparatus 1 which can supply in a time zone in which the power supply cannot be secured is selected, and the available supply amount and the price are notified (step S33). The power supply procurement is updated (step S34), and the procurement amount from the power storage apparatus 1 is notified. The power storage apparatus satisfying the updated procurement amount is selected, and the discharge scenario is distributed to each power storage apparatus 1 and the integration unit 3 (step S35). From the viewpoints of charging and discharging of the power storage apparatus 1 to maintain the supply and demand balance, control between the integration unit 3 and each power storage apparatus 1, and the like, a scenario is distributed in which exchange is performed between the power storage apparatus 1 in which surplus is generated even when discharging and the power storage apparatus 1 in shortage (step S36).

Regarding the latest demand prediction and power supply procurement, it is confirmed whether power supply can be secured again (step S37 and step S38). In a case where the power supply cannot be secured (step S38: No), an exchange simulation is performed, the power storage apparatus 1 which can supply in a time zone in which the power supply cannot be secured is selected, and the available supply amount and the price are notified (step S39). The power supply procurement is updated (step 40), and the power storage apparatus satisfying the updated procurement amount is selected, and the discharge scenario is distributed to each power storage apparatus 1 and the integration unit 3 (step S41). A scenario in which exchange is performed between the power storage apparatus 1 in which surplus is generated even when discharging and the power storage apparatus 1 in shortage is distributed (step S42).

In the real-time control after the hour-ahead market (after the gate is closed), in a case where there is a difference in demand results, that is, a difference between plan and results (step S43 and step S44: Yes), a charging/discharging scenario is distributed to the additionally chargeable/dischargeable power storage apparatus 1 and the integration unit 3 (step S45). A scenario in which the SOC is appropriately balanced in accordance with the SOC of the power storage apparatus 1 is distributed.

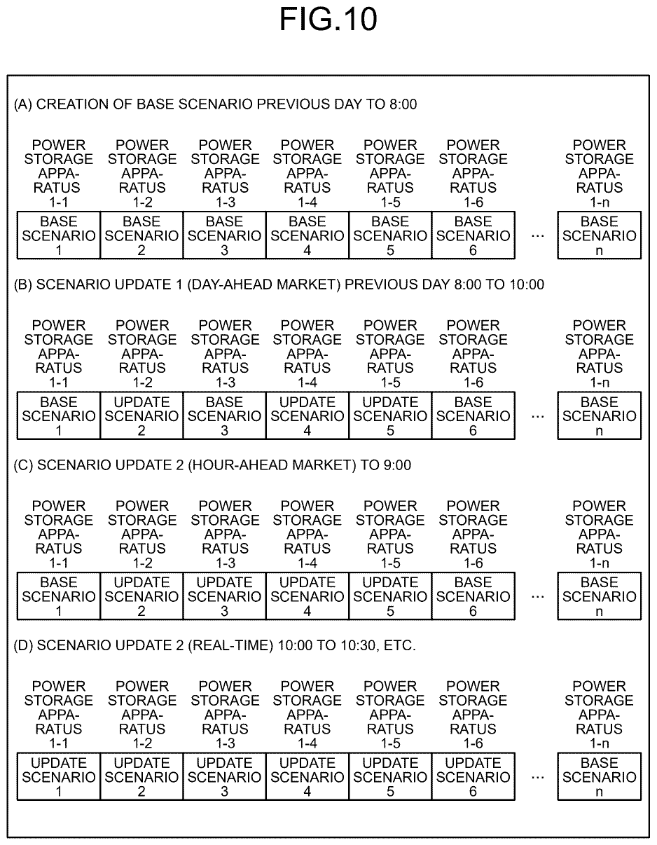

The above scenario (control data) update will be described with reference to FIG. 10.

FIG. 10 is a diagram illustrating an example of scenario update. A scenario of the power storage apparatus 1-1 is referred to as a scenario 1 or the like. It similarly applies to the power storage apparatus 1-2 to the power storage apparatus 1-n.

As illustrated in (A) of FIG. 10, base scenarios of all the power storage apparatuses 1 are generated and distributed. As illustrated in (B) of FIG. 10 and (C) of FIG. 10, in the day-ahead market and the hour-ahead market, a scenario of the power storage apparatus 1 that performs power exchange with the integration unit 3 is generated and updated as necessary. Further, as illustrated in (D) of FIG. 10, the scenario is updated in real time even after the gate is closed.

The power storage apparatus 1 to which the update scenario is distributed can efficiently distribute the power between the power storage apparatuses 1 by setting only the integration unit 3 as the exchange adjustment partner in the time zone of the first power exchange and setting the other power storage apparatuses 1 as the exchange adjustment partners at other times.

According to the above control, it is possible to supply and demand power not only according to power supply and demand for minimizing an imbalance between power generation and demand of a retail electricity provider or the like, but also to the supply and demand adjustment market and the wholesale electricity market.

In an embodiment, information regarding power may be presented to the consumer D. Such presentation may be performed by, for example, the power storage apparatus 1.

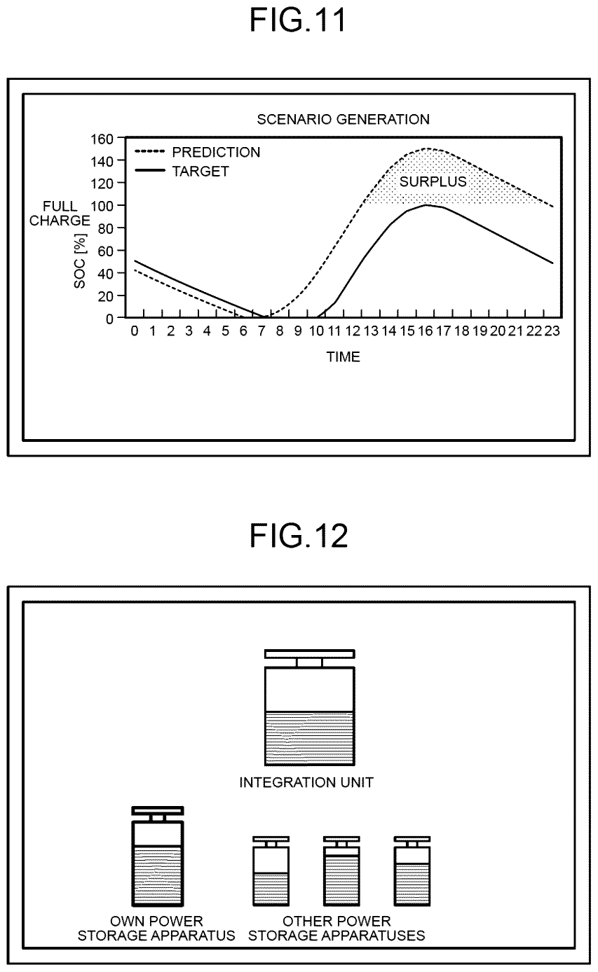

The power storage apparatus 1 may include a user interface (UI) for information presentation and the like. An example of the UI is a display or the like. This will be described with reference to FIGS. 11 and 12.

FIG. 11 is a diagram illustrating an example of a UI. In this example, the scenario is graphically displayed. A broken line graph line indicates a prediction value of the SOC. The solid line graph line indicates the transition of the target SOC for efficiently using electricity without generating surplus or deficiency. In the exemplified case, by actively using electricity from 8:00 to 16:00 and saving at other times, it is possible to more efficiently use power and lower electricity charges of consumers. The power usage in one day is visually expressed and presented so that the consumer intuitively understands the power usage, which leads to a change in behavior of the consumer D, thereby efficiently using the power.

FIG. 12 is a diagram illustrating another example of the UI. In this example, the SOC of each power storage apparatus 1 is visualized and displayed. In addition to the power storage apparatus 1 (own power storage apparatus) used by the consumer D, the power statuses of the power storage apparatuses 1 (other power storage apparatuses) used by other consumers D and the integration unit 3 are displayed. By comparing these electricity statuses, the consumer D can make a determination to supply electricity when electricity of other power storage apparatuses 1 or electricity of the integration unit 3 (electricity of the power grid G) is deficient, or to consume (demand) electricity when there is a surplus. The efficient use of electricity can be promoted by leading to the behavior change of the consumer D.

### 5. EXAMPLE OF HARDWARE CONFIGURATION

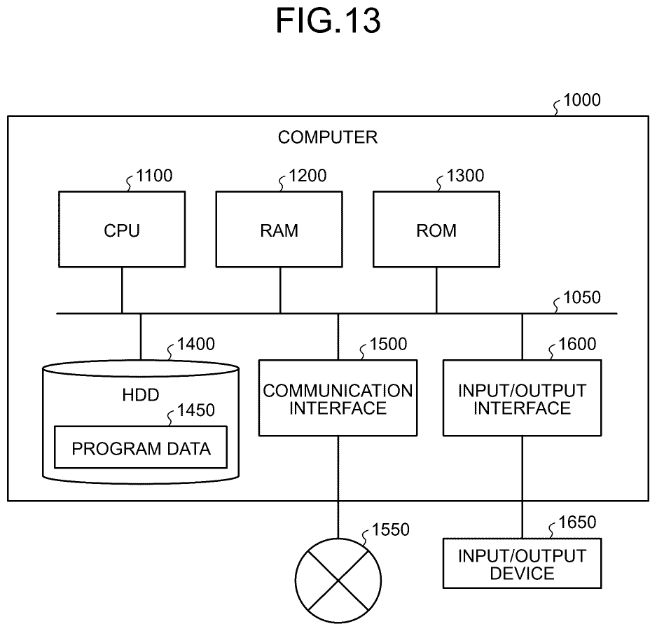

Each of the above-described apparatuses and the like, for example, the power storage apparatus 1, the integration unit 3, the control data generation apparatus 4, and the supply and demand management system 5 may include a computer. An example will be described with reference to FIG. 13.

FIG. 13 is a diagram illustrating an example of a hardware configuration of an apparatus or the like. The exemplified computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records a program (for example, a control program) for executing each operation according to the present disclosure which is an example of the program data 1450.

The communication interface 1500 is an interface for the computer 1000 to connect to an external network 1550 (for example, the Internet). For example, the CPU 1100 receives data from other equipment or transmits data generated by the CPU 1100 to other equipment via the communication interface 1500.

The input/output interface 1600 is an interface for connecting the input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

At least some of the functions of the power storage apparatus 1, the integration unit 3, the control data generation apparatus 4, and the supply and demand management system 5 described above may be realized, for example, by the CPU 1100 of the computer 1000 executing a program (control program) loaded on the RAM 1200. In addition, the HDD 1400 stores a program and the like according to the present disclosure. Note that the CPU 1100 reads the program data 1450 from the HDD 1400 and executes the program data, but as another example, these programs may be acquired from another apparatus via the external network 1550.

### 6. EFFECTS OF EXAMPLES

The technology described above is specified as follows, for example. One of the disclosed techniques is a control data generation apparatus 4. As described with reference to FIGS. 1 to 5 and the like, the control data generation apparatus 4 performs: generating the control data indicating the scenario describing the target SOC for the time of each of the plurality of power storage apparatuses 1 connected to the power grid G and the requested power amount Erequest corresponding to the difference between the plan value Eplan and the actual value Ereal of the charge/discharge power amount with respect to the power grid G of the entire plurality of power storage apparatuses 1; transmitting the data indicating at least the scenario among the generated control data to the corresponding power storage apparatus 1; and transmitting the data indicating at least the requested power amount Erequest among the generated control data to the integration unit 3 that communicates with the plurality of power storage apparatuses 1. The charging and discharging includes a first power exchange that is a power exchange between the entire plurality of power storage apparatuses 1 and the power grid G and is performed on the basis of an exchange adjustment result between the integration unit 3 and the plurality of power storage apparatuses 1, and a second power exchange that is a power exchange between the plurality of power storage apparatuses 1 and is performed on the basis of an exchange adjustment result between the plurality of power storage apparatuses 1. According to such a control data generation apparatus 4, it is possible to achieve both the first power exchange and the second power exchange.

As described with reference to FIGS. 2 to 4 and the like, in the first power exchange, at least some power storage apparatuses 1 of the entire plurality of power storage apparatuses 1 may charge and discharge the power with respect to the power grid G such that the charge/discharge power of the entire power storage apparatuses 1 with respect to the power grid G approaches the requested power amount Erequest. For example, the plan value Eplan is a plan value in a unit period, and in the first power exchange, at least some power storage apparatuses 1 of the plurality of power storage apparatuses 1 may charge and discharge the power with respect to the power grid G such that a value corresponding to the division period of the actual value approaches a value corresponding to the division period of the plan value for each division period obtained by dividing the unit period into a plurality of periods. The integration unit 3 may select one or more power storage apparatuses 1 that can charge or discharge the power with respect to the power grid G from the plurality of power storage apparatuses 1, and in the first power exchange, the selected power storage apparatuses 1 may charge or discharge the power with respect to the power grid G such that the charge/discharge power amount with respect to the power grid G of the entire power storage apparatuses 1 selected by the integration unit 3 approaches the requested power amount Erequest. For example, by performing the first power exchange in this manner, the actual value Ereal can be brought close to the plan value Eplan.

As described with reference to FIG. 6 and the like, the scenario may further describe the exchange adjustment partner of each of the plurality of power storage apparatuses 1, and the control data generation apparatus 4 may transmit, to the corresponding power storage apparatus 1, data indicating a scenario in which the exchange adjustment partner is limited so as to avoid overlapping implementation of the first power exchange and the second power exchange. The control data generation apparatus 4 may transmit data indicating a scenario in which the exchange adjustment partner is limited to the integration unit 3 to the power storage apparatus 1 (for example, the power storage apparatus 1-1 and the power storage apparatus 1-2) that charges or discharges the power with respect to the power grid G in the first power exchange. For example, the first power exchange and the second power exchange can be cooperated in this manner.

As described with reference to FIG. 2 and the like, the operation mode of the power storage apparatus 1 can be selected from a plurality of modes, and the control data generation apparatus 4 may generate data indicating the scenario such that the first power exchange and the second power exchange are performed on the basis of the priority corresponding to the selected mode. The plurality of modes may include a surplus power minimization mode, a power cost minimization mode, a deficient power minimization mode, and a disaster countermeasure mode. Power exchange can be performed according to the purpose of the mode.

The control method described with reference to FIGS. 1 to 5 and the like is also one of the disclosed techniques. The control method includes: generating the control data indicating the scenario describing the target SOC for the time of each of the plurality of power storage apparatuses 1 connected to the power grid G and the requested power amount Erequest corresponding to the difference between the plan value Eplan and the actual value Ereal of the charge/discharge power amount with respect to the power grid G of the entire plurality of power storage apparatuses 1; transmitting the data indicating at least the scenario among the generated control data to the corresponding power storage apparatus 1; and transmitting the data indicating at least the requested power amount Erequest among the generated control data to the integration unit 3 that communicates with the plurality of power storage apparatuses 1. The charging and discharging includes a first power exchange that is a power exchange between the entire plurality of power storage apparatuses 1 and the power grid G and is performed on the basis of an exchange adjustment result between the integration unit 3 and the plurality of power storage apparatuses 1, and a second power exchange that is a power exchange between the plurality of power storage apparatuses 1 and is performed on the basis of an exchange adjustment result between the plurality of power storage apparatuses 1. Even with such a control method, as described above, it is possible to achieve both the first power exchange and the second power exchange.

The control program described with reference to FIGS. 1 to 5, 13, and the like is also one of the disclosed techniques. The control program causes the computer 1000 to execute processing of: generating the control data indicating the scenario describing the target SOC for the time of each of the plurality of power storage apparatuses 1 that performs charging and discharging connected to the power grid G and the requested power amount Erequest corresponding to the difference between the plan value Eplan and the actual value Ereal of the charge/discharge power amount with respect to the power grid G of the entire plurality of power storage apparatuses 1; transmitting the data indicating at least the scenario among the generated control data to the corresponding power storage apparatus 1; and transmitting the data indicating at least the requested power amount Erequest among the generated control data to the integration unit 3 that communicates with the plurality of power storage apparatuses 1. The charging and discharging includes a first power exchange that is a power exchange between the entire plurality of power storage apparatuses 1 and the power grid G and is performed on the basis of an exchange adjustment result between the integration unit 3 and the plurality of power storage apparatuses 1, and a second power exchange that is a power exchange between the plurality of power storage apparatuses 1 and is performed on the basis of an exchange adjustment result between the plurality of power storage apparatuses 1. Even with such a control program, as described above, it is possible to achieve both the first power exchange and the second power exchange.

Note that the present technology can relate to the goal 7 “Affordable and Clean Energy” and the goal 13 “Climate Action” of the Sustainable Development Goals (SDGs) adopted at the UN summit in 2015.

The present technology is a technology related to an electricity network (for example, a smart grid) that enables bidirectional flow of electricity and data while detecting and responding to a change in the usage status of renewable energy by a digital communication technology, and it is also possible to reduce greenhouse gas (GHG) emissions by using renewable energy.

Note that the effects described in the present disclosure are merely examples and are not limited to the disclosed contents. Other effects may be provided.

Although the embodiments of the present disclosure have been described above, the technical scope of the present disclosure is not limited to the above-described embodiments as it is, and various modifications can be made without departing from the gist of the present disclosure. In addition, components of different embodiments and modifications may be appropriately combined.

Note that the present technology can also have the following configurations.
(1) A control data generation apparatus that performs:
   generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses;
   transmitting data indicating at least the scenario among the control data generated to a power storage apparatus corresponding;
   transmitting data indicating at least the scenario among the control data generated to a power storage apparatus corresponding; and
   transmitting data indicating at least the requested power amount among the control data generated to an integration unit that communicates with the plurality of power storage apparatuses, in which
   the charging and discharging includes:
   a first power exchange that is a power exchange between the entire plurality of power storage apparatuses and the power grid, the first power exchange being performed on the basis of an exchange adjustment result between the integration unit and the plurality of power storage apparatuses; and
   a second power exchange that is a power exchange between the plurality of power storage apparatuses, the second power exchange being performed on the basis of an exchange adjustment result between the plurality of power storage apparatuses.
(2) The control data generation apparatus according to (1), wherein
   in the first power exchange, at least some power storage apparatuses of the plurality of power storage apparatuses charge or discharge power with respect to the power grid such that charge/discharge power of the entire plurality of power storage apparatuses with respect to the power grid approaches the requested power amount.
(3) The control data generation apparatus according to (1) or (2), wherein
   the plan value is a plan value in a unit period, and
   in the first power exchange, at least some power storage apparatuses of the plurality of power storage apparatuses charge or discharge power with respect to the power grid such that a value corresponding to a division period of an actual value approaches a value corresponding to a division period of a plan value for each division period obtained by dividing the unit period into a plurality of periods.
(4) The control data generation apparatus according to any one of (1) to (3), wherein
   the integration unit selects one or more power storage apparatuses that can charge or discharge power with respect to the power grid from the plurality of power storage apparatuses, and
   in the first power exchange, the power storage apparatuses selected charges or discharges power with respect to the power grid such that a charge/discharge power amount of the entire power storage apparatuses selected by the integration unit with respect to the power grid approaches the requested power amount.
(5) The control data generation apparatus according to any one of (1) to (4), wherein
   the scenario further describes an exchange adjustment partner of each of the plurality of power storage apparatuses, and
   the control data generation apparatus transmits, to a power storage apparatus corresponding, data indicating a scenario in which the exchange adjustment partner is limited to avoid overlapping implementation of the first power exchange and the second power exchange.
(6) The control data generation apparatus according to (5), wherein
   the control data generation apparatus transmits data indicating a scenario in which the exchange adjustment partner is limited to the integration unit to the power storage apparatus that charges or discharges power with respect to the power grid in the first power exchange.
(7) The control data generation apparatus according to any one of (1) to (6), wherein
   an operation mode of the power storage apparatus is selectable from a plurality of modes, and
   the control data generation apparatus generates data indicating the scenario such that the first power exchange and the second power exchange are performed on a basis of priority corresponding to the mode selected.
(8) The control data generation apparatus according to (7), wherein
   the plurality of modes includes a surplus power minimization mode, a power cost minimization mode, a deficient power minimization mode, and a disaster countermeasure mode.
(9) A control method including:
   generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses;
   transmitting data indicating at least the scenario among the control data generated to a power storage apparatus corresponding;
   transmitting data indicating at least the scenario among the control data generated to a power storage apparatus corresponding; and
   transmitting data indicating at least the requested power amount among the control data generated to an integration unit that communicates with the plurality of power storage apparatuses, in which
   the charging and discharging includes:
   a first power exchange that is a power exchange between the entire plurality of power storage apparatuses and the power grid, the first power exchange being performed on the basis of an exchange adjustment result between the integration unit and the plurality of power storage apparatuses; and
   a second power exchange that is a power exchange between the plurality of power storage apparatuses, the second power exchange being performed on the basis of an exchange adjustment result between the plurality of power storage apparatuses.
(10) A control program for causing a computer to execute processing of:
   generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses;
   transmitting data indicating at least the scenario among the control data generated to a power storage apparatus corresponding; and
   transmitting data indicating at least the requested power amount among the control data generated to an integration unit that communicates with the plurality of power storage apparatuses, wherein
   the charging and discharging includes:
   a first power exchange that is a power exchange between the entire plurality of power storage apparatuses and the power grid, the first power exchange being performed on a basis of an exchange adjustment result between the integration unit and the plurality of power storage apparatuses; and
   a second power exchange that is a power exchange between the plurality of power storage apparatuses, the second power exchange being performed on a basis of an exchange adjustment result between the plurality of power storage apparatuses.

### REFERENCE SIGNS LIST

1 POWER STORAGE APPARATUS
11 STORAGE BATTERY
12 POWER CONVERTER
13 POWER GENERATION/DEMAND POWER MEASUREMENT UNIT
14 CONTROL DATA STORAGE UNIT
15 POWER EXCHANGE CONTROL UNIT
2 POWER GENERATION APPARATUS
3 INTEGRATION UNIT
31 CONTROL DATA STORAGE UNIT
32 POWER EXCHANGE CONTROL UNIT
4 CONTROL DATA GENERATION APPARATUS
41 ACTUAL VALUE AGGREGATION UNIT
42 POWER STORAGE APPARATUS SUPPLY AND DEMAND SIMULATION IMPLEMENTATION UNIT
43 CONTROL DATA GENERATION UNIT
44 CONTROL DATA UPDATE UNIT
45 PLAN VALUE AGGREGATION UNIT
46 PLAN/ACTUAL DIFFERENCE CALCULATION UNIT
47 CONTROL DATA GENERATION UNIT
48 PROCURABLE AMOUNT CALCULATION UNIT
49 PROCURABLE AMOUNT NOTIFICATION UNIT
50 CONTROL DATA GENERATION UNIT
5 SUPPLY AND DEMAND MANAGEMENT SYSTEM
G POWER GRID
PL POWER LINE
VPP VIRTUAL POWER PLANT

1. A control data generation apparatus that performs:
generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses;
transmitting data indicating at least the scenario among the control data generated to a power storage apparatus corresponding; and
transmitting data indicating at least the requested power amount among the control data generated to an integration unit that communicates with the plurality of power storage apparatuses, wherein the charging and discharging includes:
a first power exchange that is a power exchange between the entire plurality of power storage apparatuses and the power grid, the first power exchange being performed on a basis of an exchange adjustment result between the integration unit and the plurality of power storage apparatuses; and
a second power exchange that is a power exchange between the plurality of power storage apparatuses, the second power exchange being performed on a basis of an exchange adjustment result between the plurality of power storage apparatuses.

2. The control data generation apparatus according to claim 1, wherein
in the first power exchange, at least some power storage apparatuses of the plurality of power storage apparatuses charge or discharge power with respect to the power grid such that charge/discharge power of the entire plurality of power storage apparatuses with respect to the power grid approaches the requested power amount.

3. The control data generation apparatus according to claim 1, wherein
the plan value is a plan value in a unit period, and
in the first power exchange, at least some power storage apparatuses of the plurality of power storage apparatuses charge or discharge power with respect to the power grid such that a value corresponding to a division period of an actual value approaches a value corresponding to a division period of a plan value for each division period obtained by dividing the unit period into a plurality of periods.

4. The control data generation apparatus according to claim 1, wherein
the integration unit selects one or more power storage apparatuses that can charge or discharge power with respect to the power grid from the plurality of power storage apparatuses, and
in the first power exchange, the power storage apparatuses selected charges or discharges power with respect to the power grid such that a charge/discharge power amount of the entire power storage apparatuses selected by the integration unit with respect to the power grid approaches the requested power amount.

5. The control data generation apparatus according to claim 1, wherein
the scenario further describes an exchange adjustment partner of each of the plurality of power storage apparatuses, and
the control data generation apparatus transmits, to a power storage apparatus corresponding, data indicating a scenario in which the exchange adjustment partner is limited to avoid overlapping implementation of the first power exchange and the second power exchange.

6. The control data generation apparatus according to claim 5, wherein
the control data generation apparatus transmits data indicating a scenario in which the exchange adjustment partner is limited to the integration unit to the power storage apparatus that charges or discharges power with respect to the power grid in the first power exchange.

7. The control data generation apparatus according to claim 1, wherein
an operation mode of the power storage apparatus is selectable from a plurality of modes, and
the control data generation apparatus generates data indicating the scenario such that the first power exchange and the second power exchange are performed on a basis of priority corresponding to the mode selected.

8. The control data generation apparatus according to claim 7, wherein
the plurality of modes includes a surplus power minimization mode, a power cost minimization mode, a deficient power minimization mode, and a disaster countermeasure mode.

9. A control method comprising:
generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses;
transmitting data indicating at least the scenario among the control data generated to a power storage apparatus corresponding; and
transmitting data indicating at least the requested power amount among the control data generated to an integration unit that communicates with the plurality of power storage apparatuses, wherein
the charging and discharging includes:
a first power exchange that is a power exchange between the entire plurality of power storage apparatuses and the power grid, the first power exchange being performed on a basis of an exchange adjustment result between the integration unit and the plurality of power storage apparatuses; and
a second power exchange that is a power exchange between the plurality of power storage apparatuses, the second power exchange being performed on a basis of an exchange adjustment result between the plurality of power storage apparatuses.

10. A control program for causing a computer to execute processing of:
generating control data indicating a scenario describing a target SOC with respect to a time of each of a plurality of power storage apparatuses that performs charging and discharging connected to a power grid and a requested power amount corresponding to a difference between a plan value and an actual value of a charge/discharge power amount with respect to the power grid of the entire plurality of power storage apparatuses;
transmitting data indicating at least the scenario among the control data generated to a power storage apparatus corresponding; and
transmitting data indicating at least the requested power amount among the control data generated to an integration unit that communicates with the plurality of power storage apparatuses, wherein
the charging and discharging includes:
a first power exchange that is a power exchange between the entire plurality of power storage apparatuses and the power grid, the first power exchange being performed on a basis of an exchange adjustment result between the integration unit and the plurality of power storage apparatuses; and
a second power exchange that is a power exchange between the plurality of power storage apparatuses, the second power exchange being performed on a basis of an exchange adjustment result between the plurality of power storage apparatuses.
